(19) United States
(12) Patent Application Publication
(10) Pub. No.: US 2016/0077601 A1
(43) Pub. Date: Mar. 17, 2016

(54) INPUT SYSTEM FOR ON-BOARD USE

(71) Applicant: Panasonic Intellectual Property Mamagement Co., Ltd., Osaka (JP)

(72) Inventor: TSUYOSHI TANAKA, Kyoto (JP)

(21) Appl. No.: 14/785,555

(22) PCT Filed: Apr. 22, 2014
(86) PCT No.: PCT/JP2014/002254

§ 371 Date: Oct. 19, 2015

(30) Foreign Application Priority Data
Apr. 25, 2013 (JP) 2013-092355

(51) Int. Cl. G06F 3/02; G06F 3/0484; G06F 3/0481; B60R 1/00; B60K 35/00

(52) U.S. Cl. CPC G06F 3/0227; B60R 1/00; B60K 35/00; G06F 3/04817; G06F 3/04845

(57) ABSTRACT

An input system for vehicles includes a steering switch and a display part. The steering switch includes an operating switch including a plurality of operating parts. The display part is connected to the operating switch and displays an operation icon including a plurality of icons corresponding to the plurality of operating parts. When one of the operating parts is pressed, one of the icons which corresponds to the pressed operating part changes. When at least one of the operating parts is slid, a direction icon is displayed on the operation icon.

### TECHNICAL FIELD

The present technical field relates to an input system for vehicle, used to operate a car air conditioner, a car audio system, and the like.

### BACKGROUND ART

Various input systems for vehicle have been developed in recent years which can change images on an in-vehicle display according to the operation of steering switches mounted on a car steering wheel.

FIG. 8 is a structural view of conventional input system 10 for vehicles.

Input system 10 includes steering switches 2 and 3 on the right and left sides, respectively, of the center of steering wheel 1. Steering switch 2 is pressed by the driver to change the images of icons 4 on its face. Steering switch 3, which can be a static touch pad, detects being slid by the driver.

Input system 10 further includes display part 5 connected to steering switches 2 and 3.

Display part 5 includes a plurality of menu views 6 of the first hierarchical level, which are arranged in the form of an arc. When the driver slides a finger across the face of steering switch 3 along the arc as shown by arrow A, menu view 6A, which is currently selected from menu views 6, changes along the arc.

Menu view 6A is assigned with a plurality of menu views 7 of the second hierarchical level. Menu views 7 are also shown on display part 5.

The same images as those of menu views 7 are shown as icons 4 on steering switch 2. Every time menu view 6A is changed, the image of the corresponding icon 4 on steering switch 2 is also changed.

When the driver presses the face of one of icons 4 on steering switch 2, the menu view 7 of the second hierarchical level which corresponds to the pressed icon 4 is confirmed.

As a result, the function of the confirmed menu view 7 of the second hierarchical level is executed.

Thus, according to the conventional input system 10, the driver selects one of menu views 6 of the first hierarchical level by steering switch 3, and then selects one of menu views 7 of the second hierarchical level by steering switch 2.

An example of conventional techniques related to the present invention is shown in Patent Literature 1.

### CITATION LIST

### Patent Literature

PTL 1: US Unexamined Patent Application Publication No. 2010/0268426

### SUMMARY OF THE INVENTION

The input system for vehicles includes a steering switch and a display part. The steering switch includes an operating switch including a plurality of operating parts. The display part is connected to the operating switch and displays an operation icon including a plurality of icons corresponding to the plurality of operating parts. When one of the operating parts is pressed, one of the icons which corresponds to the pressed operating part changes. When at least one of the operating parts is slid, a direction icon is displayed on the operation icon.

### BRIEF DESCRIPTION OF DRAWINGS

FIG. 1 is a structural view of an input system for vehicles in accordance with an exemplary embodiment.

FIG. 2 shows a layout of the input system for vehicles in accordance with the exemplary embodiment.

FIG. 3A is a top view of a first steering switch of the input system for vehicles in accordance with the exemplary embodiment.

FIG. 3B is a top view of a second steering switch of the input system for vehicles in accordance with the exemplary embodiment.

FIG. 4A shows a state of a display part of the input system for vehicles in accordance with the exemplary embodiment, which is obtained by a pressing motion.

FIG. 4B shows a state of the display part of the input system for vehicles in accordance with the exemplary embodiment, which is obtained by a pressing motion.

FIG. 4C shows a state of the display part of the input system for vehicles in accordance with the exemplary embodiment, which is obtained by a pressing motion.

FIG. 4D shows a state of the display part of the input system for vehicles in accordance with the exemplary embodiment, which is obtained by a pressing motion.

FIG. 5A shows a state of the display part of the input system for vehicles in accordance with the exemplary embodiment, which is obtained by a sliding motion.

FIG. 5B shows a state of the display part of the input system for vehicles in accordance with the exemplary embodiment, which is obtained by a sliding motion.

FIG. 5C shows a state of the display part of the input system for vehicles in accordance with the exemplary embodiment, which is obtained by a sliding motion.

FIG. 5D shows a state of the display part of the input system for vehicles in accordance with the exemplary embodiment, which is obtained by a sliding motion.

FIG. 6A shows a lighted operating switch of the input system for vehicles in accordance with the exemplary embodiment.

FIG. 6B shows an unlighted operating switch of the input system for vehicles in accordance with the exemplary embodiment.

FIG. 7A shows a state of the display part of the input system for vehicles in accordance with the exemplary embodiment.

FIG. 7B shows a state of the display part of the input system for vehicles in accordance with the exemplary embodiment.

FIG. 7C shows a state of the display part of the input system for vehicles in accordance with the exemplary embodiment.

FIG. 7D shows a state of the display part of the input system for vehicles in accordance with the exemplary embodiment.

FIG. 8 is a structural view of a conventional input system for vehicles.

### DESCRIPTION OF EMBODIMENT

In conventional input system 10, steering switch 2 is pressed whereas steering switch 3 is slid, so that the driver has to perform both pressing and sliding motions. Those drivers who are used to pressing motions feel awkward to slide switch 3, whereas those who are used to sliding motions feel awkward to press switch 2. Thus, conventional input system 10 is not easy to use for some drivers.

The exemplary embodiment will now be described with reference to drawings.

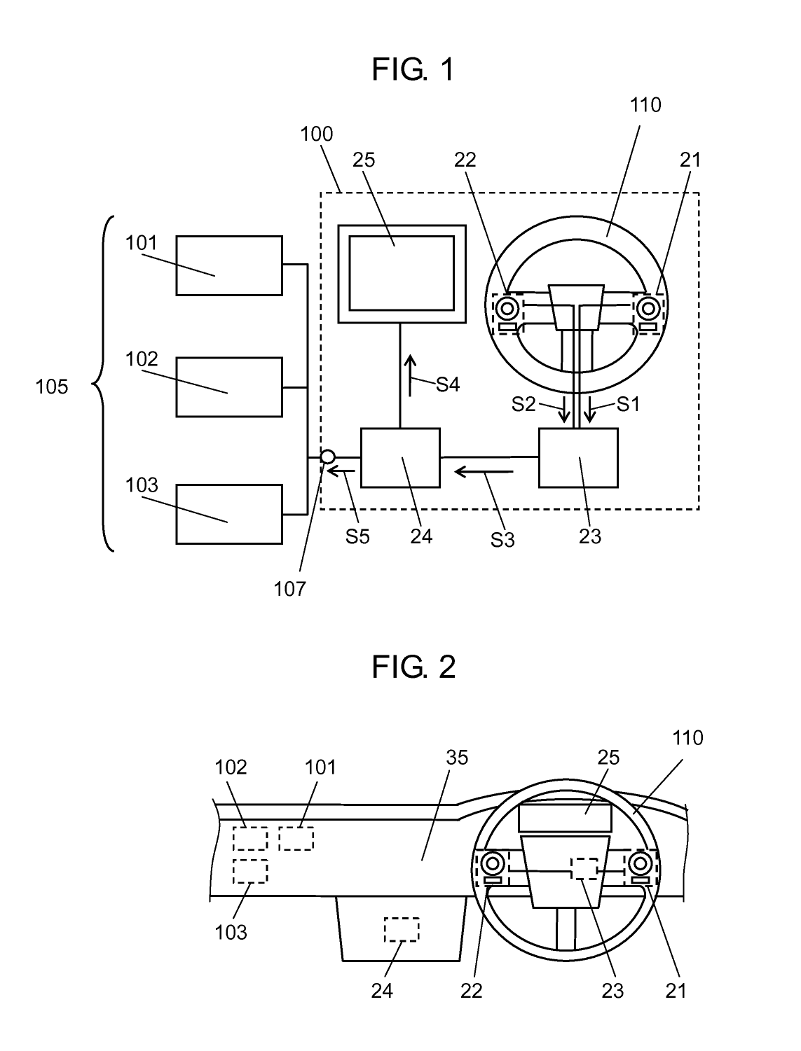

FIG. 1 is a structural view of input system 100 for vehicles in accordance with the exemplary embodiment. Input system 100 includes first steering switch 21, second steering switch 22, and display part 25. Input system 100 may further include switch controller 23 and central controller 24.

First steering switch 21 and second steering switch 22 are located on the right and left sides, respectively, of the center of steering wheel 110.

Switch controller 23 is connected to first steering switch 21 and second steering switch 22. Controller 23 receives first and second operation signals S1 and S2 from first and second steering switches 21 and 22, respectively, and then converts these signals into a switch control signal S3.

Central controller 24 is connected to switch controller 23 and display part 25. Controller 24 is further connected to in-vehicle control unit 105, such as air-conditioner controller 101, audio controller 102, and out-of-vehicle communication controller 103 so as to control the input and output signals of in-vehicle control unit 105.

Central controller 24 receives the switch control signal S3 from switch controller 23 and provides display part 25 with a display control signal S4, and in-vehicle control unit 105 with a control signal S5.

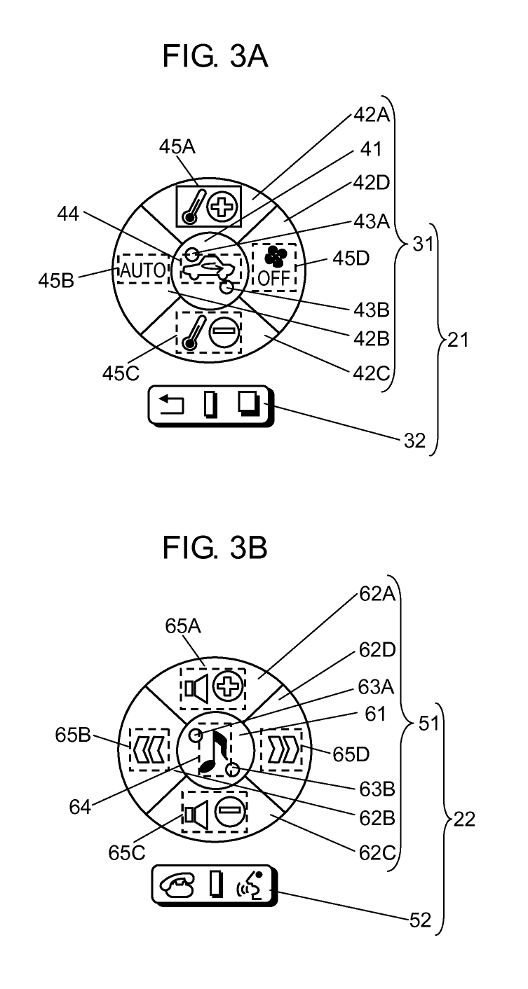

In other words, input system 100 includes output port 107 electrically connected to central controller 24, which provides output port 107 with the control signal S5. The signal S5 is used to control in-vehicle control unit 105 according to the operation of operating switch 31 (described later with reference to FIG. 3A).

Network protocols for vehicles, for example, Controller Area Network (CAN), FlexRay, Media Oriented Systems Transport (MOST), and Local Interconnect Network (LIN) are used. Some network protocols can eliminate central controller 24 and provide interconnection between switch controller 23, display part 25, and in-vehicle control unit 105.

Air-conditioner controller 101 controls the air conditioner in the vehicle. Audio controller 102 controls the selection of music, the volume, and other conditions of the audio system. Out-of-vehicle communication controller 103 allows the driver to make or answer phone calls via his/her mobile phone or to acquire road traffic information used in the car navigation system (not shown).

Display part 25, which can be placed on instrument panel 35 (see FIG. 2), shows images corresponding to the display control signal S4 received from central controller 24.

The layout of input system 100 thus structured will now be described with reference to FIG. 2. FIG. 2 shows the layout of input system 100 in accordance with the exemplary embodiment.

When steering wheel 110 is in a neutral position, first and second steering switches 21 and 22 are located on the right and left sides, respectively, of the center of wheel 110. Switch controller 23 is located between first steering switch 21 and second steering switch 22, and connected to them via cables, harnesses, or other devices.

Display part 25 is located in a place on instrument panel 35 which the driver can easily see. Instrument panel 35 includes central controller 24, air-conditioner controller 101, audio controller 102, and out-of-vehicle communication controller 103.

Each of switch controller 23, display part 25, air-conditioner controller 101, audio controller 102, and out-of-vehicle communication controller 103 is connected to central controller 24 through cables, harnesses, or other devices.

The following is a specific structure of first steering switch 21 and second steering switch 22.

FIG. 3A is a top view of first steering switch 21 of input system 100 in accordance with the exemplary embodiment.

First steering switch 21 includes operating switch 31 and push button 32.

Operating switch 31 includes circular operating part 41 located at the center (central operating part) and arc-shaped operating parts 42A-42D arranged around operating part 41 (peripheral operating parts). Operating switch 31 further includes rotation bodies 43A and 43B partially protruding from the face of operating part 41 so that the driver can roll them. Each of operating parts 41 and 42A-42D has a two-layer structure: a membrane switch to be turned on under low pressure, and a push switch to be turned on under somewhat large pressure. Operating part 41 has the image of functional view 44 printed on its face, and operating parts 42A-42D have the images of functional views 45A-45D, respectively, printed on their faces to represent their functions.

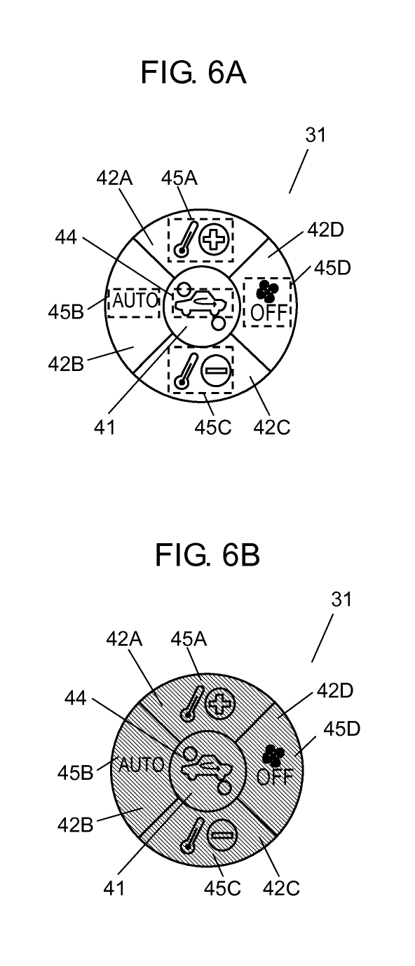

Push button 32 is used to switch the input mode of operating switch 31. Push button 32 is turned on and off to switch between the functions corresponding to functional views 44, 45A-45D shown in operating switch 31 and other functions. The details will be described later with reference to FIGS. 6.

FIG. 3B is a top view of second steering switch 22 of input system 100 in accordance with the exemplary embodiment. Second steering switch 22, which is similar in shape to first steering switch 21, includes operating switch 51 and push button 52.

Operating switch 51 includes circular operating part 61 located at the center and arc-shaped operating parts 62A-62D arranged around operating part 61. Operating switch 51 further includes rotation bodies 63A and 63B partially protruding from the face of operating part 61. Each of operating parts 61 and 62A-62D has a two-layer structure: a membrane switch to be turned on under low pressure, and a push switch to be turned on under somewhat large pressure. Operating part 61 has the image of functional view 64 printed on its face, and operating parts 62A-62D have the images of functional views 65A-65D, respectively, printed on their faces to represent their functions.

Push button 52, which relates to hands-free talking on the phone, is turned on and off by the driver to turn on and off hands-free talking.

Functional views 44 and 45A-45D of operating switch 31 shown in FIG. 3A relate to air-conditioner controller 101. Functional views 64 and 65A-65D of operating switch 51 shown in FIG. 3B relate to audio controller 102. Operating switch 31 is used to control air-conditioner controller 101, and operating switch 51 is used to control audio controller 102.

Operating switches 31, 51 and push buttons 32, 52 can be illuminated from the back side. Switches 31 and 51 are illuminated when push button 32 is pressed or when the car accessories are turned on, allowing functional views 44, 45A-45D, 64, and 65A-65D to be more visible to the driver.

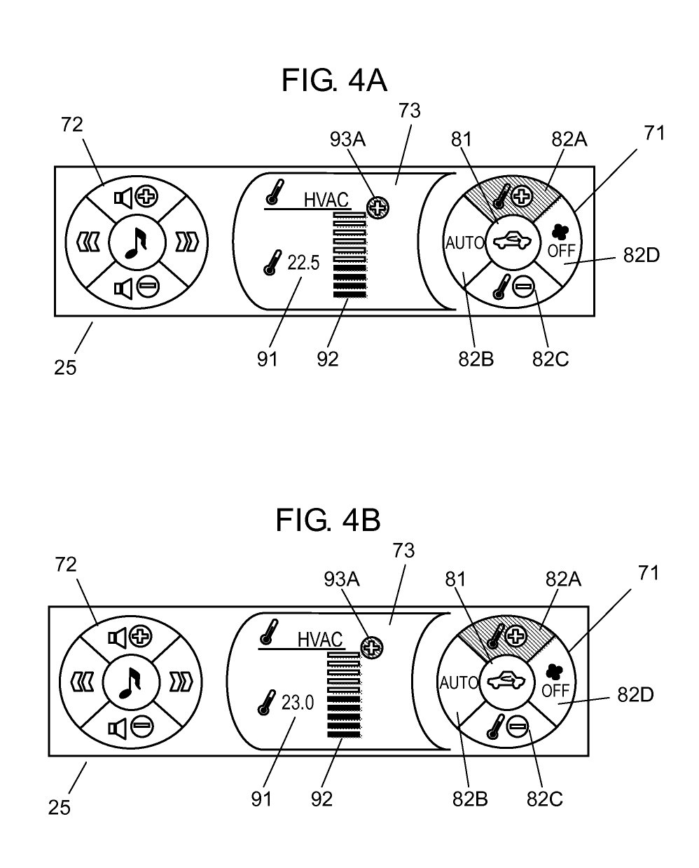

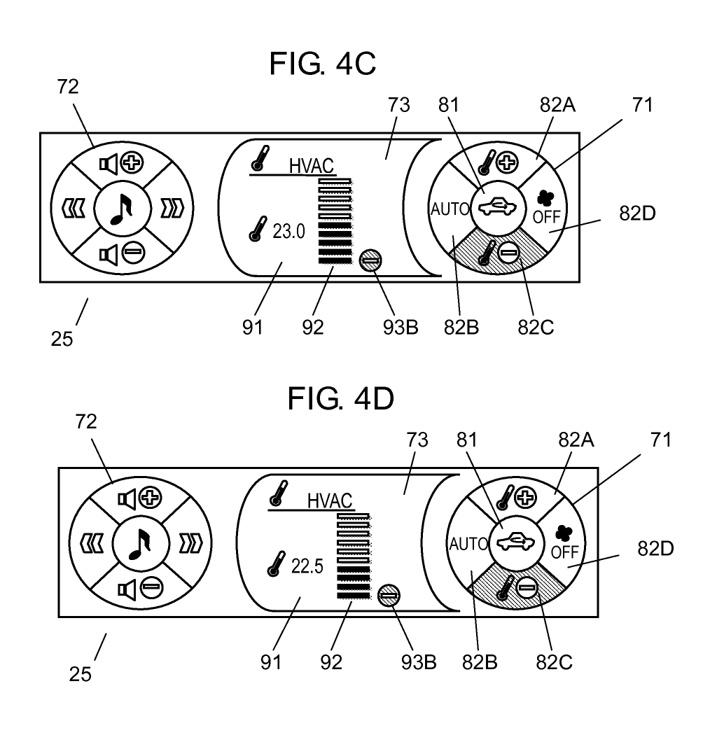

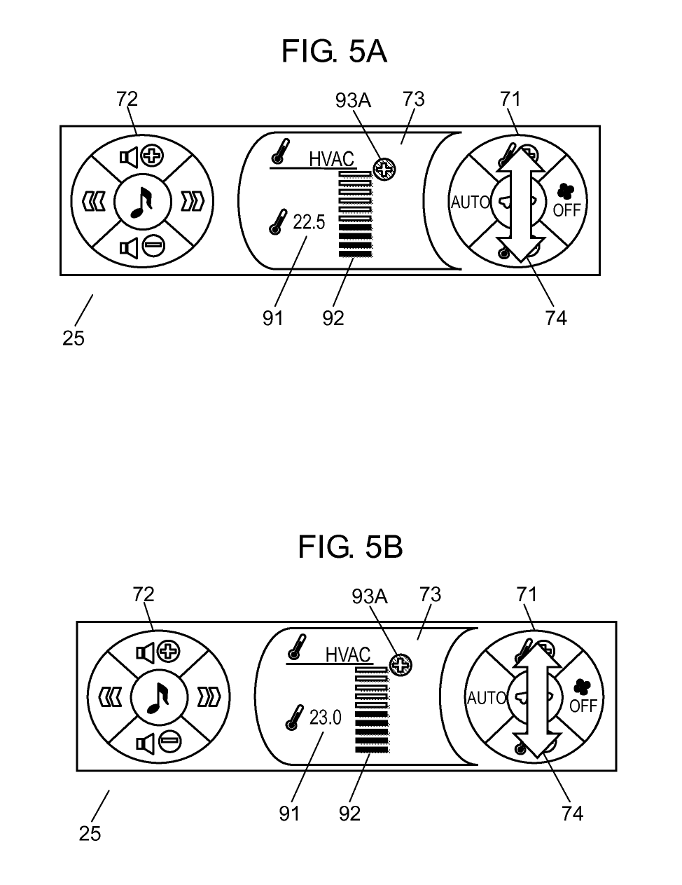

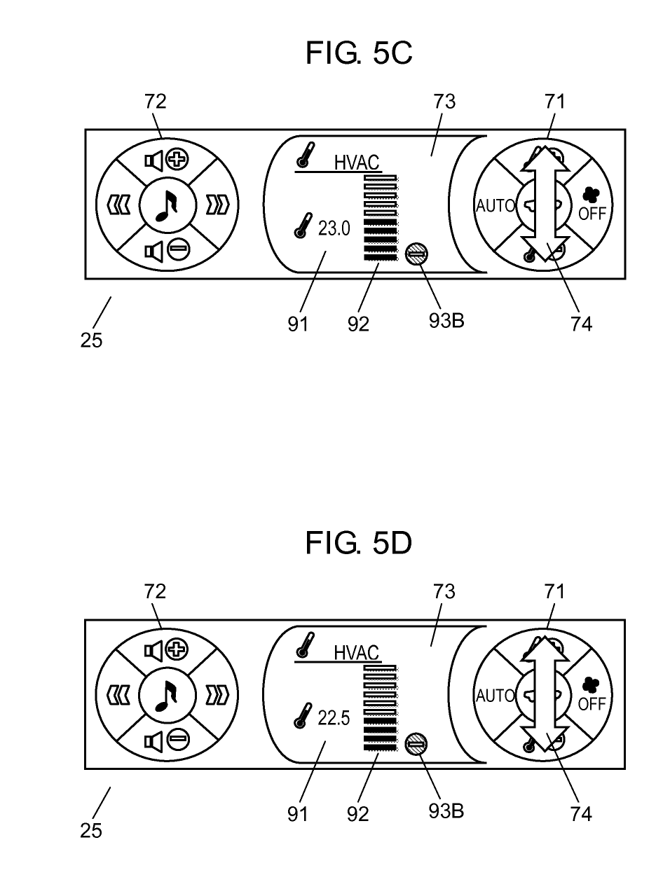

The following is a description of images on display part 25 when operating switches 31 and 51 are operated, with reference to FIGS. 4A-4D and 5A-5B.

FIGS. 4A-4D show different states of display part 25 of input system 100 in accordance with the exemplary embodiment, which are obtained when operating switch 31 is pressed.

As shown in FIG. 4A, display part 25 has first operation-icon 71 corresponding to operating switch 31 shown in FIG. 3A, second operation-icon 72 corresponding to operating switch 51 shown in FIG. 3B, and setup data display 73 showing the current state. First operation-icon 71 includes central icon 81 and peripheral icons 82A-82D.

Icon 81 corresponds to operating part 41 shown in FIG. 3A, and icons 82A-82D correspond to operating parts 42A-42D, respectively, shown in FIG. 3A.

When the driver presses operating part 42A, the membrane switch of the first layer is turned on, allowing icon 82A and increase-decrease display 93A in setup data display 73 to be shown under illumination. Operating part 42A corresponds to functional view 45A used to increase the temperature, and accordingly, the image representing functional view 45A is shown in setup data display 73.

Setup data display 73 shows the currently set temperature in two ways: counter value display 91 and gauge display 92. When operating part 42A is further pressed, the push switch of the second layer is turned on. As a result, counter value display 91 increases by 0.5° C. to become 23.0° C., and gauge display 92 increases by one increment as shown in FIG. 4B.

When the driver presses operating part 42C in the state of FIG. 4B, the membrane switch of the first layer is turned on, and consequently, the images on display part 25 are changed to the state shown in FIG. 4C. Icon 82C corresponding to operating part 42C and increase-decrease display 93B in setup data display 73 are illuminated, whereas increase-decrease display 93A and icon 82A are darkened. Operating part 42C corresponds to functional view 45C used to decrease the temperature, and accordingly, the image representing functional view 45C is shown in setup data display 73. When the driver further presses operating part 42C, the push switch of the second layer is turned on. As a result, counter value display 91 decreases by 0.5° C. to become 22.5° C., and gauge display 92 decreases by one increment as shown in FIG. 4D.

FIGS. 5A-5D show different states of display part 25 of input system 100 in accordance with the exemplary embodiment, which are obtained when operating switch 31 is slid.

Rotation bodies 43A and 43B shown in FIG. 3A rotate when the driver runs (slides) a finger across the face of operating switch 31. When the driver runs a finger across rotation bodies 43A and 43B to rotate them toward operating part 42A, setup data display 73 shows the image representing the function of operating part 42A as shown in FIG. 5A. In addition, direction icon 74 indicating the directions the driver can perform a sliding motion is displayed on first operation-icon 71.

When, in this case, the driver runs a finger across rotation bodies 43A and 43B to move them toward operating part 42A, counter value display 91 increases by 0.5° C. to become 23.0° C., and gauge display 92 increases by one increment as shown in FIG. 5B.

When, in this case, the driver runs a finger across the top of rotation bodies 43A and 43B to rotate them toward operating part 42C, setup data display 73 shows the image representing the function of operating part 42C as shown in FIG. 5C.

When, in this case, the driver further runs a finger across rotation bodies 43A and 43B to rotate them toward operating part 42C, counter value display 91 decreases by 0.5° C. to become 22.5° C., and gauge display 92 decreases by one increment as shown in FIG. 5D.

Thus, when first steering switch 21 is pressed, the corresponding icon in first operation-icon 71 is illuminated and shown distinguishably from the other icons. When, on the other hand, first steering switch 21 is slid, direction icon 74 indicating the directions the driver can perform a sliding motion is displayed on first operation-icon 71.

As described above, the driver can choose between pressing and sliding first steering switch 21 to execute the same function in whichever case. Therefore, those drivers who are used to pressing motions can press the switches, whereas those who are used to sliding motions can slide them. Thus, input system 100 is easy to use for both types of drivers.

The following is a description of different states of illumination of operating switch 31. When push button 32 shown in FIG. 3A is pressed, the input mode of operating switch 31 changes. More specifically, when operating switch 31 is darkened, the images on display part 25 change.

FIGS. 6A and 6B show operating switch 31 of input system 100 in accordance with the exemplary embodiment when it is illuminated and when it is darkened, respectively. When operating switch 31 is illuminated as shown in FIG. 6A, functional views 44 and 45A-45D shown on operating switch 31 are easily visible. When, on the other hand, push button 32 is pressed as shown in FIG. 6B, operating switch 31 is darkened to make functional views 44 and 45A-45D almost invisible.

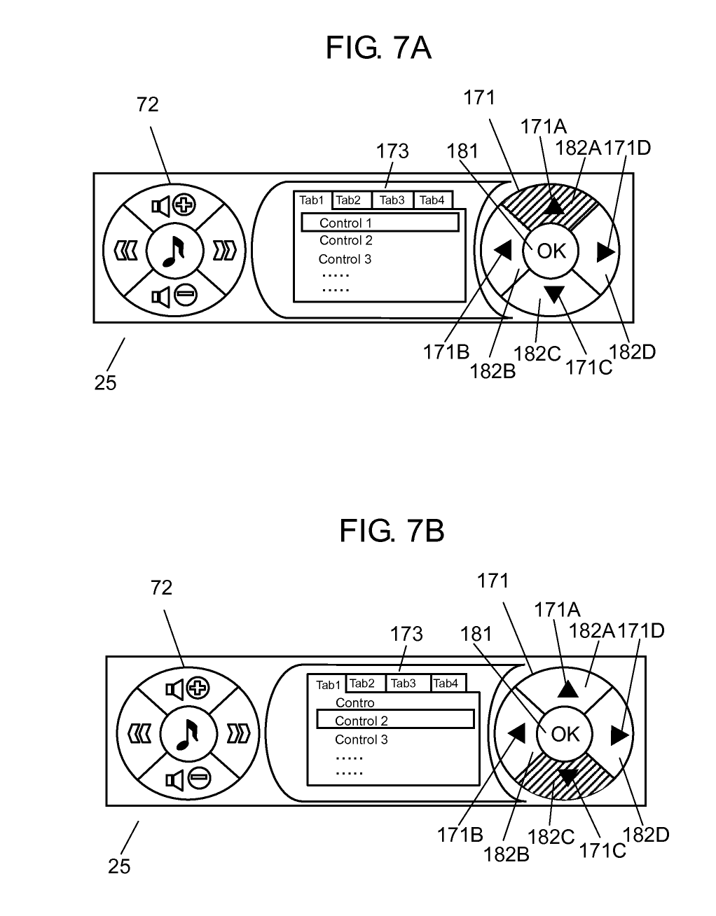

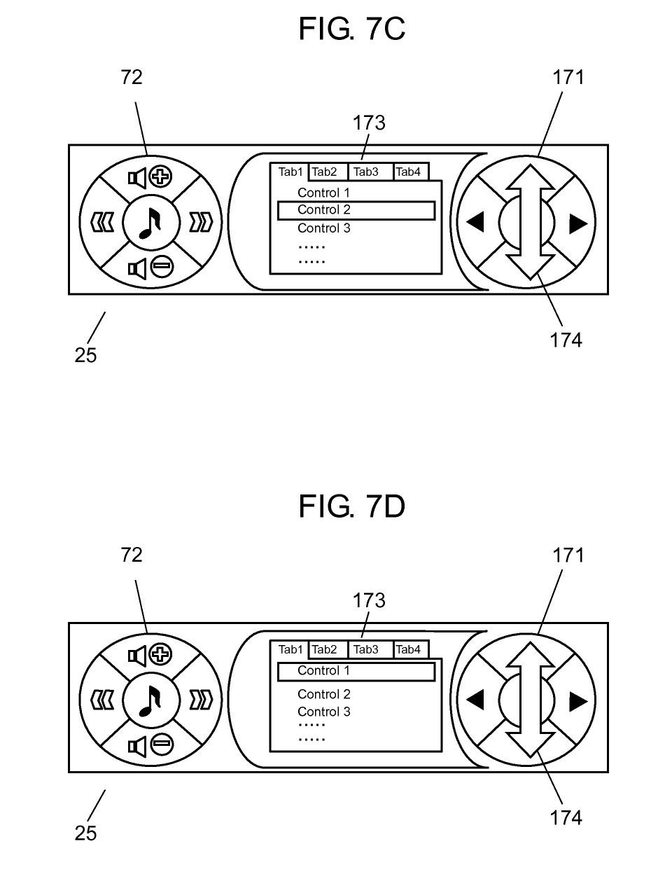

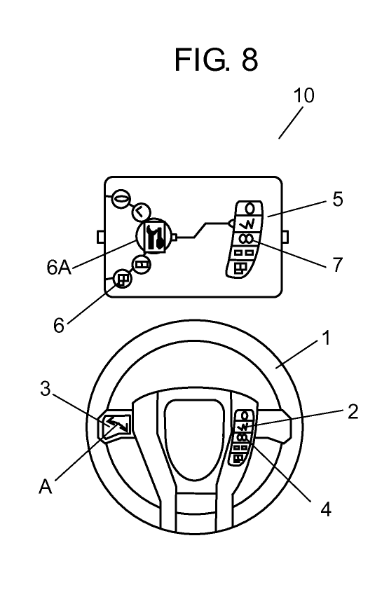

FIGS. 7A-7D show different states of display part 25 of input system 100 in accordance with the exemplary embodiment. When operating switch 31 is darkened, display part 25 shows the images as in FIG. 7A. First operation-icon 171 includes central icon 181 and peripheral icons 182A-182D.

As shown in FIG. 7A, display part 25 shows first operation-icon 171 corresponding to operating switch 31 shown in FIG. 6B. Display part 25 also shows second operation-icon 72 corresponding to operating switch 51 of FIG. 3B and setup data display 173 indicating the current setting condition.

In FIG. 7A, central icon 181 corresponds to operating part 41 of operating switch 31 shown in FIG. 6B. Peripheral icons 182A-182D correspond to operating parts 42A-42D, respectively, shown in FIG. 6B.

Operating switch 31 is used to select “Control 1”, “Control 2”, or “Control 3” in the list display and “Tab 1”, “Tab 2”, “Tab 3”, or “Tab 4” in the tab display of setup data display 173 shown in FIG. 7A.

For example, in the case that operating switch 31 is assigned to phone functions, the driver can operate operating switch 31 and make phone calls via out-of-vehicle communication controller 103.

For example, “Control 1” indicates “dialing a number in received call history”, “Control 2” indicates “dialing a number in dialed calls history”, and “Control 3” indicates “dialing a number in the favorites”. In addition, for example, “Tab 1” indicates “Phone”, “Tab 2” indicates “Trip Data”, “Tab 3” indicates “Screen Setting”, and “Tab 4” indicates “Sound Setting”. The “Phone” shows dialed calls and other data. The “Trip Data” shows the mileage and other data of the vehicle. The “Screen Setting” shows items to set the display screen, and the “Sound Setting” shows items to set the sound.

When the driver presses operating part 42A, the membrane switch of the first layer is turned on and icon 182A corresponding to operating part 42A is illuminated (FIG. 7A). When the driver further presses operating part 42A, the push switch of the second layer is turned on to execute the “dialing a number in received call history” of “Control 1”.

When the driver presses operating part 42C, the membrane switch of the first layer is turned on, and the currently selected function changes from “Control 1” to “Control 2” (FIG. 7B). When, in this state, the driver presses operating part 42A, the currently selected function changes from “Control 2” to “Control 1”.

When the driver presses operating part 42D, the currently selected tab changes from “Tab 1” to “Tab 2”. When, in this state, the driver presses operating part 42B, the tab returns from “Tab 2” to “Tab 1”.

First operation-icon 171 further includes directional displays 171A and 171C for allowing the driver to move and select items in setup data display 173 vertically, that is, to move and select the items in the list display. Directional displays 171A and 171C have functions corresponding to the pressing of operating parts 42A and 42C, respectively. First operation-icon 171 further includes directional displays 171B and 171D for allowing the driver to move and select items in setup data display 173 horizontally, that is, to move and select the items in the tab display. Directional displays 171B and 171D have functions corresponding to the pressing of operating parts 42B and 42D, respectively.

FIGS. 7C and 7D show the case in which the driver slides operating switch 31 to rotate rotation bodies 43A and 43B. When the driver runs a finger across rotation bodies 43A and 43B to rotate them toward operating part 42A or 42C, direction icon 174 is displayed on first operation-icon 171.

When, in the state of FIG. 7C, the driver runs a finger across rotation bodies 43A and 43B to rotate them toward operating part 42A, the selected function changes from “Control 2” to “Control 1” as shown in FIG. 7D. When, on the other hand, the driver runs a finger across rotation bodies 43A and 43B to rotate them toward operating part 42C, the selected function changes from “Control 2” to “Control 3”.

As described above, operating switch 31 can be used for functional views other than functional views 44 and 45A-45D shown on switch 31. In the case of using switch 31 for functional views other than functional views 44 and 45A-45D, switch 31 can be darkened to make these functional views invisible. As a result, the driver recognizes that the functions of operating switch 31 have been changed. Directional displays 171A-171D shown in first operation-icon 171 provides the driver with more operational options and variations.

The exemplary embodiment uses two-layer push switches in detecting the operations of operating switches 31 and 51, but may alternatively use single-, three-, or more-layer switches. Note that “pressing” operating switches 31 and 51 includes “touching” them.

Push buttons 32 and 52 of first and second steering switches 21 and 22, respectively, are not essential components. Similarly, central controller 24 and switch controller 23 are not essential components, either.

The exemplary embodiment uses two rotation bodies 43A and 43B in detecting the sliding of steering switches 21 and 22, but may alternatively use one, three, or more rotation bodies. The locations of the rotation bodies may be other than on operating parts 41 and 61. Furthermore, the rotation bodies can be replaced by any other device, such as a touch panel and a touch pad, which can detect sliding motions.

In the case of using a touch panel or a touch pad as first steering switch 21 or steering switch 22, the driver can only bring a finger close to it as well as can touch it. More specifically, the switch may be configured to detect pressing and sliding motions when the drive brings a finger close to it. In this case, the “pressing motion” means to bring a finger close to first steering switch 21, and “sliding motion” means to move a finger in parallel with the face of first steering switch 21.

The exemplary embodiment uses two steering switches 21 and 22, but may alternatively use one, three, or more steering switches.

Operating part 41 may be a static switch. In this case, the driver puts a finger on operating part 41 and slides it toward operating parts 42A-42D so as to execute the same function as the rotation of rotation bodies 43A and 43B.

As described above, input system 100 for vehicles in accordance with the exemplary embodiment includes first steering switch 21 including operating parts 41 and 42A-42D that can be pressed or slid, and display part 25 for displaying operation icon 71 corresponding to first steering switch 21. When first steering switch 21 is operated, operation icon 71 is displayed in such a manner that the one selected from operating parts 41 and 42A-42D is distinguishable from the others. When first steering switch 21 is slid, on the other hand, not only operation icon 71 but also direction icon 74 is displayed to indicate the directions the driver can perform a sliding motion.

With the above structure, those drivers who are used to pressing motions can press the switches, whereas those who are used to sliding motions can slide them. Thus, input system 100 is easy to use for both types of drives.

First steering switch 21 has functional views 44 and 45A-45D placed on operating parts 41 and 42A-42D, respectively. When the operating parts are pressed, the functions corresponding to the functional views placed on the operating parts are executed. When operating parts 41 and 42A-42D are slid, the functions corresponding to functional views 44 and 45A-45D placed on the operating parts are executed. Thus, functional views 44 and 45A-45D are displayed on operating parts 41 and 42A-42D, respectively, allowing the diver to easily understand how to use them.

First steering switch 21 can be illuminated or darkened to switch the input mode, providing the driver with various operational options.

As described above, input system 100 in accordance with the exemplary embodiment includes steering switch 21 (first steering switch) including operating switch 31 including operating parts 41 and 42A-42D. Input system 100 further includes display part 25, which is connected to operating switch 31 and shows operation icon 71 including icons 81 and 82A-82D corresponding to operating parts 41 and 42A-42D, respectively.

When one of operating parts 41 and 42A-42D is pressed, one of icons 81 and 82A-82D which corresponds to the pressed operating part changes. When, on the other hand, at least one of operating parts 41 and 42A-42D is slid, direction icon 74 is displayed on operation icon 71.

Input system 100 in accordance with the exemplary embodiment further includes switch controller 23 connected to steering switch 21. Switch controller 23 converts the operation signal 51 (first operation signal), which is generated when steering switch 21 is operated, into the switch control signal S3. Input system 100 further includes central controller 24 connected to switch controller 23 and display part 25. Central controller 24 converts the switch control signal S3 into display control signal S4 for changing the images on display part 25 and transmits the signal S4 to display part 25.

### INDUSTRIAL APPLICABILITY

The input system in accordance with the exemplary embodiment is mainly useful in vehicles because of its easiness to use for both those drivers who are used to sliding motions and those who are used to pressing motions.

### REFERENCE MARKS IN THE DRAWINGS

21 first steering switch

22 second steering switch

23 switch controller

24 central controller

25 display part

31, 51 operating switch

32, 52 push button

41, 42A-42D, 61, 62A-62D operating part

43A, 43B, 63A, 63B rotation body

44, 45A-45D, 64, 65A-65D functional view

71, 72, 171 operation icon

73, 173 setup data display

74, 174 direction icon

81, 82A-82D, 181, 182A-182D icon

91 counter value display

92 gauge display

93A, 93B increase-decrease display

100 input system for vehicles

101 air-conditioner controller

102 audio controller

103 out-of-vehicle communication controller

105 in-vehicle control unit

107 output port

110 steering wheel

171A-171D directional display

S1 first operation signal

S2 second operation signal

S3 switch control signal

S4 display control signal

S5 control signal

1. An input system for vehicles, comprising:
a steering switch including an operating switch including a plurality of operating parts, the operating parts including:
a central operating part; and
a plurality of peripheral operating parts arranged around the central operating part; and
a display part connected to the operating switch and displaying an operation icon including a plurality of icons corresponding to the plurality of operating parts,
wherein
the central operating part includes a rotation body partially protruding from a face of the central operating part,
when one of the operating parts is pressed, one of the icons which corresponds to the pressed operating part changes, and
when the rotation body is slid, a direction icon is displayed on the operation icon.

2. The input system for vehicles of claim 1, further comprising:
a switch controller connected to the steering switch and converting an operation signal, which is generated when the steering switch is operated, into a switch control signal; and
a central controller connected to the switch controller and the display part, the central controller converting the switch control signal into a display control signal and transmitting the display control signal to the display part.

3. The input system for vehicles of claim 2, further comprising an output port electrically connected to the central controller,
wherein the central controller outputs a control signal for controlling an in-vehicle control unit to the output port in response to an operation of the operating switch.

4. The input system for vehicles of claim 1, wherein
the steering switch further includes a push button; and
when the push button is pressed, an input mode of the operating switch changes.

5. The input system for vehicles of claim 4, wherein
the operating switch can be illuminated or darkened in response to switching of the push button; and
the input mode differs between when the operating switch is illuminated and when the operating switch is darkened.

6-7. (canceled)

8. The input system for vehicles of claim 1, wherein
the operating parts have respective functions displayed thereon; and
the functions are executed by operating the steering switch.
